(19) United States
(12) Patent Application Publication
(10) Pub. No.: US 2021/0068484 A1
(43) Pub. Date: Mar. 11, 2021

(54) POCKET FOR A GARMENT, AND CLOTHING PROVIDED WITH SUCH A POCKET

(71) Applicant: Derckules B.V., Zandvoort (NL)

(72) Inventor: Derck Roelf MEKKERING, Zandvoort (NL)

(73) Assignee: Derckules B.V., Zandvoort (NL)

(21) Appl. No.: 16/499,334

(22) PCT Filed: Mar. 28, 2018
(86) PCT No.: PCT/NL2018/050189

§ 371 Date: Sep. 30, 2019

(30) Foreign Application Priority Data
Mar. 29, 2017 (NL) 2018603

(51) Int. Cl. A41D 31/26; A41D 27/20

(52) U.S. Cl. CPC A41D 31/265; A41D 27/205

(57) ABSTRACT

The invention relates to a pocket for a garment, in particular to a pocket comprising a rear side configured to be turned towards the body of a person and a front side which is connected to the rear side and configured to face away from the body of a person. The invention also relates to a garment provided with at least one pocket according to the invention.

The invention relates to a pocket for a garment, in particular to a pocket comprising a rear side configured to be turned towards the body of a person and a front side which is connected to the rear side and configured to face away from the body of a person. The invention also relates to a garment provided with at least one pocket according to the invention.

In today's digital society, both the use of and the development of (threadless) telecommunications equipment are still growing rapidly. Due to developments regarding mobile networks, such as for example Wifi, 4G and 5G, and the increase in mobile calls and mobile data traffic by telecommunications equipment, such as smartphones, tablets and laptops, the amount of high-frequency radiation to which users are exposed per unit time increases. Smartphones in particular are usually stored in clothing pockets and carried by a user, as a result of which the smartphone is situated on or at least close to the body of the user for a prolonged period of time. Whether this increasing radiation intensity results in increasing health risks for users is not yet clear. Medical and scientific studies do show that the body may possibly be biologically affected by electromagnetic radiation and/or radio waves originating from electronic appliances. In this case, changes in the DNA, the cells, the blood cells, and/or the brain may for example occur. By contrast, the human body is often able to stop such biological changes if the user is no longer exposed to the abovementioned radiation. However, due to a lack of evidence that exposure to high-frequency radiation over a prolonged time is not detrimental to health, and the increasing awareness that the increasing radiation intensity might pose a health risk, there is an increasing need to protect the body in a practical manner against high-frequency radiation which originates from a smartphone (or other mobile telecommunication equipment) which the user carries around in his or her clothing.

It is a first object of the invention to provide a clothing component by means of which the human body, in particular vital body parts of the human body, can be protected in an improved way against high-frequency radiation emitted (and/or received) by smartphones.

A first object of the invention is to provide a clothing component by means of which, on the one hand, the human body, in particular vital body parts of the human body, can be protected in an improved way against high-frequency radiation emitted (and/or received) by a smartphone, and wherein, on the other hand, the mobile range of the smartphone can be ensured to the greatest possible degree.

In order to achieve at least one of the abovementioned objects, the invention provides a pocket for a garment, comprising a rear side configured to be turned towards the body of a person, and a front side which is connected to the rear side and configured to face away from the body of a person, wherein the rear side is at least partly made of a radio-wave-reflecting first textile, which first textile comprises at least one metal-comprising thread, and wherein the front side is at least partly made of a radio-wave-reflecting second textile, which second textile comprises at least one metal-comprising thread. The pocket according to the invention may be incorporated in a garment, such as a pair of trousers, jacket, waistcoat, etc., as a clothing component. The pocket according to the invention may be used for putting away a smartphone and/or other type of mobile telecommunications device, such as a (small) tablet. What is special about the pocket according to the invention is the fact that the pocket is made of a particular first textile and a particular second textile, which first textile and which second textile are configured to reflect, and thus substantially block, radio waves (high-frequency electromagnetic radiation) having a wavelength of approximately 1 millimetre (300 GHz) to approximately 1 metre (300 MHz), more particularly radio waves in the (ultra)high-frequency range (30-3000 MHz) which have a wavelength of 10 millimetres to 1 metre. Such radio waves are inter alia used for the following communication standards: GSM, CDMA, 3G, 4G, 5G, and Wifi (IEEE 802.11). The first textile and the second textile achieve this electromagnetic radiation-reflecting quality as a result of the use of metal-comprising threads in the textile, resulting in the creation of an electromagnetic barrier or reflective screen. If an electronic telecommunications device, such as for example a mobile telephone, in particular a smartphone, is placed in a pocket according to the invention which is provided in or on a garment, a part of the body which is situated in the direct vicinity of the telephone, in particular the part of the body which surrounds and is situated under and behind the telephone, will be screened off and thus be protected against the radio waves emitted (and received) by the telecommunications device. Since the rear side (rear wall) of the pocket is turned towards the body of the person and is at least partly, and is preferably largely, more preferably substantially completely, made of the radio-wave-reflecting first textile, the body tissue situated under and/or behind the rear side will no longer be exposed at all to the emitted electromagnetic radiation. The radio-wave-reflecting first textile will reflect the radio waves to a large degree, usually substantially completely, in a direction turned away from the body, as a result of which the body is relatively well-protected against the emitted radiation. The radio-wave-reflecting second textile, which usually only forms a(n edge) part of the front side (front wall) of the pocket, will additionally prevent the radio waves emitted by the telecommunications device, usually a smartphone, from being able to reach the body. The pocket according to the invention thus forms a radio-wave-blocking sleeve or barrel, by means of which the body can be protected against radio waves emitted from the pocket. Incidentally, due to advertising material and/or a (visual) mark on the pocket and/or the garment of which the at least one pocket forms part, a user will usually know that the user is wearing a garment which is provided with the radio-wave-reflecting pocket, as a result of which a user will more readily store a smartphone (or another mobile telecommunications device) in the respective pocket according to the invention and not in another conventional pocket which may be provided in the garment. The advantage of incorporating the radio-wave-blocking (reflecting) metal-comprising thread or threads in the (first and second) textile is that the thread forms an integral part of the textile (fabric), in which case the textile can already be given the desired radio-wave-blocking property during the production process in a relatively simple and efficient manner. Therefore, no separate additional measures, such as an additional layer, have to be applied to the textile after manufacture of the textile in order to enable (at least a part of) the pocket as such to reflect radio waves, which is favourable from a practical, logistical and financial point of view. Moreover, by incorporating the textile as (part of the) front side and rear side of the pocket, substantially the entire rear wall of the pocket may solely be formed by the first (possibly single-layered) textile, and, optionally, substantially the entire front wall of the pocket may be solely formed by the second (possibly single-layered) textile. Although the first textile and the second textile are primarily configured in order to reflect radio waves, reflection (and/or blocking) of other electromagnetic radiation by the textile is not excluded. The first textile and the second textile may have an identical composition. However, it is also conceivable for the composition (construction) of the first textile and the second textile to differ from one another. Further variant embodiments of the pocket according to the invention will be described below.

Preferably, the rear side (rear wall) of the pocket is substantially completely made of the radio-wave-reflecting first textile. In this way, a part of the body which is situated behind it can be protected as well as possible against radio waves emitted (from the pocket). However, a front side (front wall) of the pocket is only partly made of the second textile, with another part of the front side being made of at least one different material, such as for example a third textile and/or a synthetic material (layer) which is substantially permeable to radio waves. The different material, such as the third textile, will thus not, or hardly, reflect emitted radio waves, as a result of which the mobile range and a good reception of the mobile telecommunications device, such as a smartphone, can be ensured as much as possible. If the third textile is used, the third textile is usually free from metal-comprising threads in order to ensure the reception of the mobile telecommunications device as much as possible. If the front side of the pocket is composed of the second textile and at least one different material, such as the aforementioned third textile, the second textile and the different material, such as the third textile, will (only) be able to overlap one another partly. This usually facilitates attachment of the material layers to each other, for example by means of sewing. Preferably, the second textile forms at least a part of a peripheral edge of the front side of the pocket. More preferably, the peripheral edge of the front side of the pocket comprises an inner lateral edge, wherein the second textile forms at least a part of the inner lateral edge. Alternatively or in addition, it is also conceivable for the peripheral edge of the front side of the pocket to comprise a bottom lateral edge, wherein the second textile forms at least a part of the bottom lateral edge. In particular if the pocket according to the invention is used as a trouser pocket in a pair of trousers, in particular a suit trouser, it is advantageous only for the inner lateral edge and(/or) the bottom lateral edge of the front side of the side to be formed by the second textile, since, in this way, on the one hand, vital body parts, in particular the genitals, can be screened off against electromagnetic radiation emitted by, for example, a smartphone from the pocket, and, on the other hand,—due to the fact that only (a part of) the lateral periphery of the pocket is formed by the second textile—sufficient mobile range of the smartphone can be ensured as much as possible (for the exchange of mobile data). At least a part of the second textile is preferably substantially strip-shaped, wherein the width of at least a part of the strip-shaped second textile is at least 5 millimetres. The maximum width of at least a part of the strip-shaped second textile is preferably at most 20 millimetres. Research has shown that a width of the strip-shaped second textile of at least 5 millimetres is required in order to achieve adequate protection of the body. A smaller width usually results in undesired exposure to a relatively large dose of radio waves. The same research has shown that the increase of the screening effect is not significant from widths of the strip-shaped second textile of 20 millimetres. In order to be able to ensure sufficient mobile range of a mobile telecommunications device situated in the pocket, it is moreover advantageous to limit the width of the strip-shaped second textile to 20 millimetres. More preferably, the width of the strip-shaped second textile is between 7 and 15 millimetres, in particular between 8 and 12 millimetres. Research shows that a width of the strip-shaped textile of (substantially) 10 millimetres is usually most ideal. The strip-shaped second textile is of an elongate (strip-shaped) shape design which may be linear, but which may also be designed differently, such as curved and/or angled. The strip-shaped second textile may form at least a part of the lateral periphery of the front side of the pocket.

It is conceivable to incorporate solid metal threads in the first textile and/or the second textile. However, it is often sufficient, and advantageous from a financial point of view, if the first textile and/or the second textile comprises at least one thread which is provided with a metal coating. In this case, the metal-coated thread comprises a non-metal core, for example a core made of nylon or cotton, which core is covered by the metal coating, wherein the weight ratio between the metal coating and the non-metal core is at least 0.11. Such a minimum ratio ensures sufficient reflection of radio waves emitted by a mobile telecommunications device positioned nearby. Preferably, at least 20 percent of the first textile and/or the second textile consists of metal-comprising threads. These metal-comprising threads are usually incorporated in the textile crosswise, so that a metal-comprising reflective grid is de facto produced. The (first and/or second) textile is usually composed of warp threads and weft threads which are interwoven with the warp threads at an angle or at right angles. In this case, it is advantageous if several warp threads and/or several weft threads are formed by a metal-comprising thread. The metal may be of different types and, if desired, several metals may be used, as an alloy and/or as a laminate. Preferably, the first textile and/or the second textile comprises at least one metal-comprising thread, wherein the metal is selected from the group consisting of: silver, copper, iron, aluminium, gold, (stainless) steel. The non-metal part of the first textile and/or the second textile and/or the third textile is preferably at least partly made of nylon, cotton, silk, linen and/or wool. Usually, the first textile and the second textile are connected to each other and in particular stitched together. This kind of attachment is usually performed on the longitudinal edges (peripheral edges) of the front side and the rear side of the pocket.

Usually, the pocket is formed by and/or the pocket is intended as a trouser pocket, a breast pocket and/or an inside pocket. Different applications of the pocket according to the invention are also conceivable.

The invention also relates to a garment provided with at least one pocket according to the invention. In this case, the garment may, for example, be formed by a pair of trousers, a jacket, a shirt, a sweater and/or a T-shirt.

The invention will be explained by means of non-limiting exemplary embodiments illustrated in the following figures, in which:

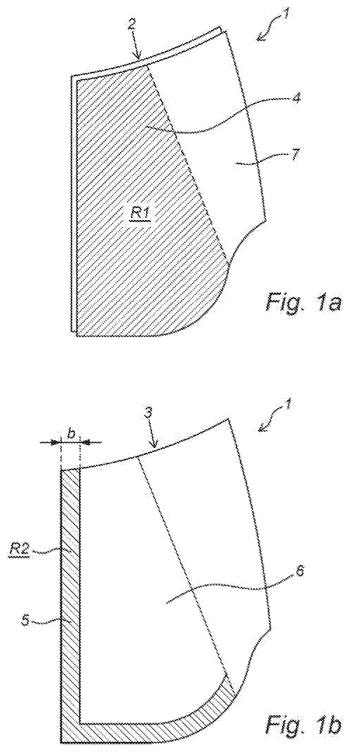

FIGS. 1a and 1b show a diagrammatic representation of a first possible embodiment of a rear side and a front side of a pocket for a garment according to the invention;

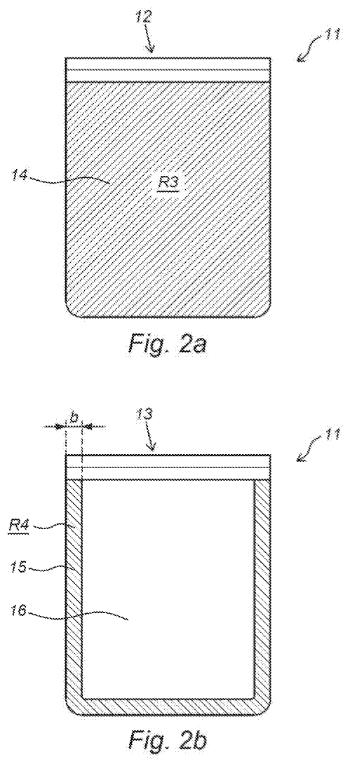

FIGS. 2a and 2b show a diagrammatic representation of a second possible embodiment of a rear side and a front side of a pocket for a garment according to the invention;

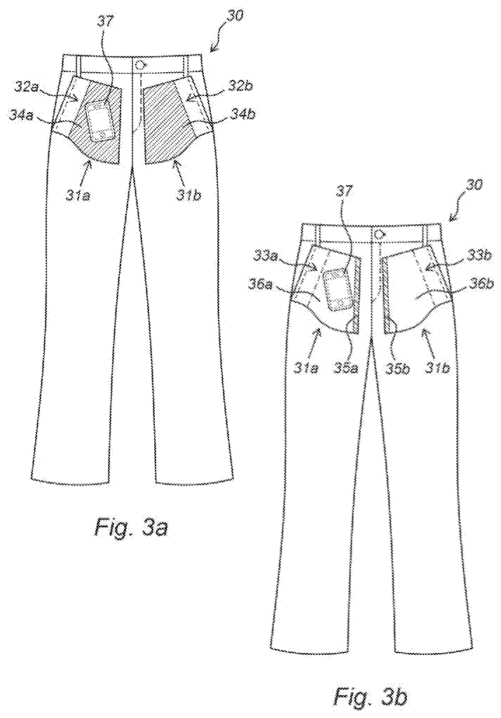

FIGS. 3a and 3b show a diagrammatic representation of a first garment provided with a pair of pockets according to the invention;

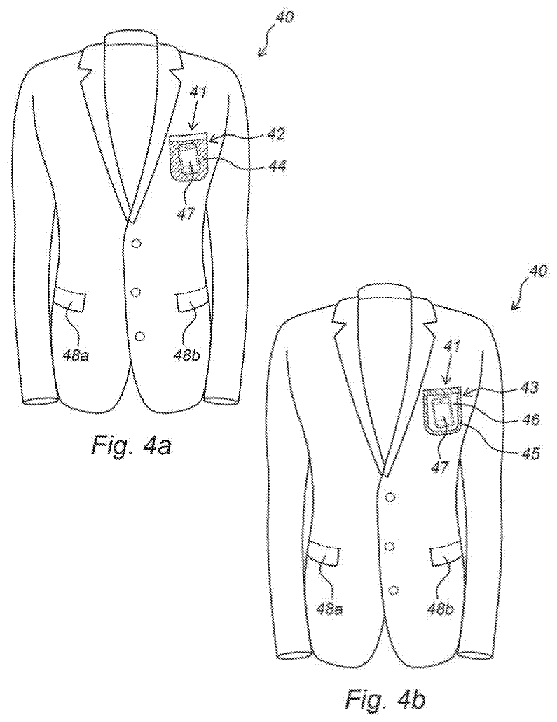

FIGS. 4a and 4b show a diagrammatic representation of a second garment provided with a pair of pockets according to the invention;

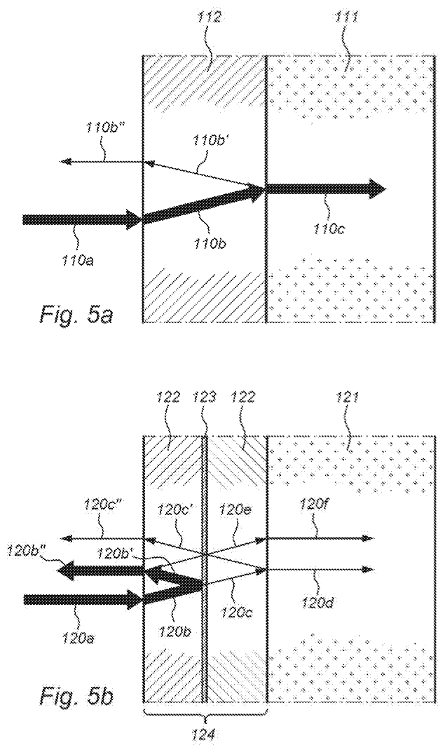

FIG. 5a shows a diagrammatic representation of the propagation of an incident radio wave in a multi-layered structure consisting of a layer of textile and a layer of body tissue;

FIG. 5b shows a diagrammatic representation of the propagation of an incident radio wave in a multi-layered structure consisting of a layer of textile enriched with metal threads according to the invention and a layer of body tissue;

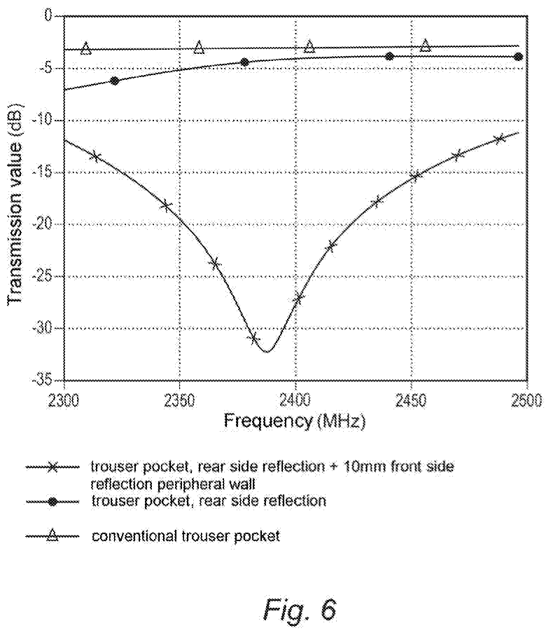

FIG. 6 shows a graph in which the results of empirical measurements of the transmission values of three trouser pockets which may or may not allow radio waves to penetrate are shown; and

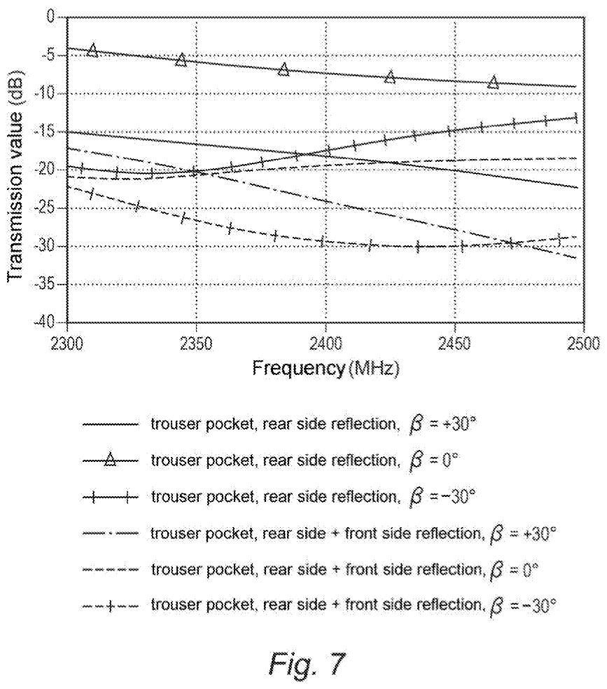

FIG. 7 shows a graph in which transmission values are shown as a function of the frequency, measured for different types of trouser pockets which are at least partly made of radio-wave-reflecting textile.

FIG. 1a shows a diagrammatic representation of a first possible embodiment of a rear side (2) of a pocket (1) for a garment according to the invention, which rear side (2) is configured to be turned towards the body of a person. The rear side (2) is configured to be connected to the front side (3) of the pocket (1), as is illustrated in FIG. 1b. In this case, the hatched portion (R1) shows the portion of the rear side (2) of the pocket (1) which is partly made of radio-wave-reflecting first textile (4). In the illustrated embodiment, the pocket (1) is configured to function as a trouser pocket of a pair of trousers. The pocket (1) is designed such that an electronic appliance placed in the pocket, such as for example a mobile telephone, is substantially completely covered by a radio-wave-reflecting first textile (4) on the side turned towards the body. The remaining part (7) of the rear side (2) may be made of a conventional textile.

FIG. 1b shows a diagrammatic representation of a front side (3) of a pocket (1) for a garment according to the invention, which front side (3) is configured to face away from the body of a person. The front side (3) of the pocket (1) is configured to be connected to a rear side (2) of the pocket (1), as is illustrated in FIG. 1a. In this case, the hatched portion (R2) shows the portion of the front side (3) of the pocket (1) which is made of a radio-wave-reflecting second textile (5). In the illustrated embodiment, the second textile (5) is strip-shaped. In this case, the second textile (5) forms at least a part of the bottom lateral edge of the front side (3) of the pocket (1). The strip-shaped second textile (5) has a predetermined width (b). The second textile (5) is connected to a third textile (6), which third textile (6) is made of a textile which is permeable to radio waves.

FIG. 2a shows a diagrammatic representation of a second possible embodiment of a rear side (12) of a pocket (11) for a garment according to the invention, which rear side (12) is configured to be turned towards the body of a person. The rear side (12) is configured to be connected to the front side (13) of the pocket (11), as is illustrated in FIG. 2b. The illustrated embodiment of the pocket (11) is in particular suitable for use as a breast pocket of, for example, a jacket. The rear side (12) of the pocket (11) is substantially completely made of a radio-wave-reflecting first textile (R3, 14).

FIG. 2b shows a diagrammatic representation of a front side (13) of a pocket (11) for a garment according to the invention, which front side (13) is configured to face away from the body of a person. The front side (13) of the pocket (11) is configured to be connected to the rear side (12) of the pocket (11), as is illustrated in FIG. 2a. The longitudinal edges of the front side (13) of the pocket (11) are made of a radio-wave-reflecting second textile (15). The reflecting edge has a width (b). The second textile (15) is connected to a third textile (16), which third textile (16) is substantially permeable to radio waves. The front side (13) is configured to be connected to the longitudinal edges of the rear side (12) by means of the outside of the longitudinal edges of the front side (13), as is illustrated in FIG. 2a.

FIGS. 3a and 3b show a diagrammatic representation of a first garment (30) provided with a pair of pockets (31a, 31b) according to the invention. In this case, FIG. 3a shows the rear sides (32a, 32b) of the pockets (31a, 31b) and FIG. 3b shows the corresponding front sides (33a, 33b) of the pair of trousers (30). The rear sides (32a, 32b) are made of a radio-wave-reflecting first textile (34a, 34b). The front sides (33a, 33b) are partly made of a radio-wave-reflecting second textile (35a, 35b) and partly made of a third textile (36a, 36b) which is substantially permeable to radio waves. A mobile telephone (37) is situated in the first pocket (31a), in which case the mobile telephone (37) is substantially completely covered by the radio-wave-reflecting first textile (34a) on the side turned towards the body. The radio-wave-reflecting second textile (35a) on the front side (33a) of the first pocket (31a) is designed such that the vital body parts are screened off from radio waves and/or radiation originating from the mobile telephone (37). In the illustrated embodiment, only the side wall of the front side (33a, 33b) turned towards the vital body parts is made of a radio-wave-reflecting second textile (35a, 35b). Optionally, an adjacent part of the side wall may also be made of a radio-wave-reflecting textile, as is illustrated in FIG. 1b.

FIGS. 4a and 4b show a diagrammatic representation of a second garment (40) provided with a pocket (41) according to the invention. The figures show a jacket (40) provided with a possible embodiment of a pocket (41) according to the invention. In this case, FIG. 4a shows the rear side (42) of the pocket (41) and FIG. 4b the front side (43) connected to the rear side (42). In this case, the rear side (43) is configured to be turned towards the body of the person wearing the jacket (40). The front side (43) is configured to face away from the body of the person. The illustrated mobile telephone (47) is substantially completely covered by the radio-wave-reflecting first textile (44) of the rear side (42) of the pocket (41). In the illustrated embodiment, the longitudinal edges of the front side (43) of the pocket (41) are completely made of a radio-wave-reflecting second textile (45). In this case, the reflecting longitudinal edges completely surround the mobile telephone (47). The remaining portion of the front side (43) consists of a third textile (46) which is substantially permeable to radio waves, so that the reception of the mobile telephone (47) is not impeded. In the illustrated embodiment of the garment (40), only the breast pocket (41) is partly made of a radio-wave-reflecting textile, but it is also conceivable for the other pockets (48a, 48b) to also be partly made of a radio-wave-reflecting textile.

FIG. 5a shows a diagrammatic representation of the propagation of an incident radio wave (110a) in a multi-layered structure consisting of a layer of conventional textile (112) which is substantially permeable to radio waves and a layer of body tissue (111). The incoming radio wave (110a) passes through the first textile layer (112) virtually completely and is then absorbed by the body tissue (111). The figure shows that the incoming wave (110a) passes through the textile (112), see wave (110b), and then largely passes through the body tissue (111), see wave (110c). Another part of the wave (110b) moving through the textile (112) is reflected as wave (110b′) and subsequently allowed to pass through as wave (110b″). In practice, multiple reflections may take place. Also, it is probable that a small part of the wave (110a) is absorbed by the textile (112).

FIG. 5b shows a diagrammatic representation of the propagation of an incident wave (120a) in a multi-layered structure consisting of a radio-wave-reflecting textile (124) and a layer of body tissue (121). The radio-wave-reflecting textile (124) comprises a layer of textile (122) provided with a radio-wave-reflecting layer (123). In this case, the reflective layer (123) consists of a textile enriched with metal threads, as used in a front side and/or rear side of a pocket according to the present invention. The incoming radio wave (120a, 120b) is virtually completely reflected by the reflective layer (123), with a reflection wave (20b′, 20b″) being formed. In the illustrated diagram, a small part of the incoming radio wave (120a) passes through the reflective layer (123) and propagates further to the body tissue (121). It is conceivable for multiple reflections to occur in the textile (122) provided with the reflective layer (123). A simple example of such multiple reflections is shown in the illustrated figure, reference being made to the illustrated radio waves (120b, 120b′, 120b″, 120c, 120c′, 120c″, 120d, 120e, 120f) which all originate from the primary incoming wave (120a). The figure indicates that virtually a complete incoming field of radio waves is reflected by the radio-wave-reflecting textile (124), and in particular by the reflective layer (123), so that only a small amount of radio-frequency energy passes through to the body tissue.

FIG. 6 shows a graph which shows the results of empirical measurements of the transmission values of a pair of trouser pockets which are at least partly made of radio-wave-reflecting textile and a trouser pocket which is made of a textile which is permeable to radio waves. In this case, the X axis shows the frequency of the emitted signal in MHz and the Y axis shows the measured transmission values in dB. For the measurements, use is made of a pair of antennas, with a first antenna transmitting a signal and a second antenna measuring this signal at a distance. In this case, the signal-transmitting antenna is situated in a trouser pocket during each experiment. A reference measurement was carried out prior to the start of the measurements. The distance between both antennas is the same for all measurements. The metal threads used during the experiments were silver yarns, in particular nylon thread provided with a silver coating. The silver yarn comprises 18 percent by weight of silver and another 82 percent by weight of nylon. Three different trouser pockets were tested, i.e. a conventional trouser pocket which allows radio waves to pass through, a trouser pocket in which only the rear side is substantially completely made of a radio-wave-reflecting textile and a trouser pocket in which the rear side is substantially completely made of a radio-wave-reflecting textile and in which the rear side is connected to a front side of the trouser pocket which is made of a radio-wave-reflecting textile on the peripheral edge.

The graph indicates that the transmission value for the conventional trouser pocket, which is made of a textile which is permeable to radio waves is equal for all emitted frequencies. The measured transmission value is 3.3 dB across the entire frequency band. This transmission value is related to an insulation value of 53%.

It can be seen that the use of a trouser pocket in which the rear side of the pocket is made of a radio-wave-reflecting textile results in a reduction in the transmission values. For example, the transmission value measured at a frequency of 2.4 GHz is 4.2 dB. This corresponds to an insulation value of 62%.

However, the greatest effect is achieved by using a trouser pocket which comprises a radio-wave-reflecting textile on both sides. During the illustrated experiment, the trouser pocket on the front side is made of a reflective layer which is situated along the peripheral wall with a width of 10 mm.

FIG. 7 shows a graph in which transmission values are illustrated as a function of the frequency, measured for different types of trouser pockets which are made of radio-wave-reflecting textile. For the measurements, a trouser pocket has been used of which only the rear side is made of radio-wave-reflecting textile and several trouser pockets of which both the rear side is made of radio-wave-reflecting textile and a part of the front side is made of radio-wave-reflecting textile. The metal threads used in the experiments consist of the above-described silver yarn.

For the measurements, use is made of a pair of antennas, with a first antenna transmitting a signal and a second antenna measuring this signal at a distance, in which case the first antenna is situated in the trouser pocket. The measurements are performed for three different mutual positions of the antennas, with the angle β between both antennas being respectively −30°, 0° or 30°. These positions simulate the situation of a wearer of trousers provided with trouser pockets while walking.

The transmission values for the trouser pocket in which both the rear side and the front side of the trouser pocket comprise a textile enriched with metal threads are average values of measurements of trouser pockets having a reflective layer on the peripheral wall with widths of 5, 10, 15 and 20 mm, respectively. Experimentally, it has been found that a reflective wall having a minimum width of 5 mm on the front side of the pocket already results in a significant drop in the measured transmission values. A widening of the reflective wall affects the transmission value, but the latter will remain in the same range for widths of 5 to 20 mm.

The graph shows that the transmission values depend on the mutual position of the antennas. The graph also shows that the use of textile enriched with metal thread on the front side of the trouser pocket results in a significant reduction in the transmission values. In practice, this means an improved protection of the body tissue against the emitted radiation.

It will be clear that the invention is not limited to the exemplary embodiments illustrated and described here, but that countless variants are possible without departing from the scope of the attached claims which will be obvious to someone skilled in the art. In this case, it is conceivable for various inventive concepts and/or technical measures of the above-described variant embodiments to be completely or partly combined without moving away from the inventive idea described in the attached claims.

The verb ‘comprise’ and conjugations thereof used in this patent document are understood to not only mean ‘comprise’, but also the expressions ‘contain’, ‘substantially contain’, ‘formed by’, and conjugations thereof.

1. Pocket for a garment, comprising:
a rear side configured to be turned towards the body of a person, and
a front side which is connected to the rear side and configured to face away from the body of a person,
wherein the rear side is at least partly made of a radio-wave-reflecting first textile, which first textile comprises at least one metal-comprising thread, and wherein the front side is at least partly made of a radio-wave-reflecting second textile, which second textile comprises at least one metal-comprising thread.

2. Pocket according to claim 1, wherein the rear side is substantially completely made of the radio-wave-reflecting first textile.

3. Pocket according to claim 1, wherein the front side is partly made of the radio-wave-reflecting second textile, and wherein at least one other part of the front side is made of a material which is substantially permeable to radio waves, in particular a third textile.

4. Pocket according to claim 3, wherein the material which is substantially permeable to radio waves is substantially free from metal-comprising threads.

5. Pocket according to claim 3, wherein the second textile and the material which is substantially permeable to radio waves partly overlap one another.

6. Pocket according to claim 3, wherein the second textile and the material which is substantially permeable to radio waves are connected to one another, preferably stitched together.

7. Pocket according to claim 3, wherein at least a part of the material which is substantially permeable to radio waves is situated at a distance from the second textile.

8. Pocket according to claim 3, wherein the second textile forms at least a part of a peripheral edge of the front side of the pocket.

9. Pocket according to claim 8, wherein the peripheral edge of the front side of the pocket comprises an inner lateral edge, and wherein the second textile forms at least a part of the inner lateral edge.

10. Pocket according to claim 8, wherein the peripheral edge of the front side of the pocket comprises a bottom lateral edge, and wherein the second textile forms at least a part of the bottom lateral edge.

11. Pocket according to claim 1, wherein at least a part of the second textile is substantially strip-shaped, wherein the width of at least a part of the strip-shaped second textile is at least 5 millimetres.

12. Pocket according to claim 1, wherein at least a part of the second textile is substantially strip-shaped, wherein the width of at least a part of the strip-shaped second textile is at most 20 millimetres.

13. Pocket according to claim 1, wherein the first textile and/or the second textile comprises at least one thread which is provided with a metal coating.

14. Pocket according to claim 13, wherein the metal-coated thread comprises a non-metal core, wherein the weight ratio between the metal coating and the non-metal core is at least 0.11.

15. Pocket according to claim 1, wherein the first textile and/or the second textile comprises at least one thread which is completely made of metal.

16. Pocket according to claim 1, wherein the first textile and/or the second textile comprises at least one metal-comprising thread, wherein the metal is selected from the group consisting of: silver, copper, iron, aluminium, gold.

17. Pocket according to claim 1, wherein at least a part of the first textile and/or the second textile and/or the third textile is at least partly made of nylon, cotton, silk, linen and/or wool.

18. Pocket according to claim 1, wherein at least 20 percent of the first textile and/or the second textile consists of metal-comprising threads.

19. Pocket according to claim 1, wherein the first textile and the second textile are connected to each other and in particular stitched together.

20. Pocket according to claim 1, wherein the pocket is formed by a trouser pocket, a breast pocket and/or an inside pocket.

21. Garment provided with at least one pocket according to claim 1.

22. Garment according to claim 21, wherein the garment is selected from the group consisting of: a pair of trousers, a jacket, a shirt, a sweater, a T-shirt.
